(19) United States
(12) Patent Application Publication
(10) Pub. No.: US 2013/0141540 A1
(43) Pub. Date: Jun. 6, 2013

(54) TARGET LOCATING METHOD AND A TARGET LOCATING SYSTEM

(71) Applicants: Per-Olof Persson, Karlskoga (SE); Folke Isaksson, Linkoping (SE); Leif Haglund, Brokind (SE)

(72) Inventors: Per-Olof Persson, Karlskoga (SE); Folke Isaksson, Linkoping (SE); Leif Haglund, Brokind (SE)

(73) Assignee: SAAB AB, Linkoping (SE)

(21) Appl. No.: 13/805,050

(22) PCT Filed: Jun. 18, 2010
(86) PCT No.: PCT/SE2010/000170

§ 371 Date: Feb. 14, 2013

(51) Int. Cl. G06K 9/00

(52) U.S. Cl. CPC G06K 9/00201
USPC 348/46; 382/103

(57) ABSTRACT

A target locating method and a target locating system. Images of a target area are recorded utilizing recording devices carried by a vehicle. The recorded images of the target area are matched with a corresponding three dimensional area of a three dimensional map including transferring a target indicator from the recorded images of the target area to the three dimensional map of the corresponding target area. The coordinates of the target indicator position are read in the three dimensional map. The read coordinates of the target indicator position are made available for position requiring equipment.

### TECHNICAL FIELD

The present invention relates to a target locating method and a target locating system, the target locating system comprising a vehicle, a ground based system and a position requiring equipment.

In connection with this application the word vehicle is to be regarded as a broad definition including airborne vehicles, such as aircrafts, helicopters and unmanned areal vehicles, ground based vehicles, such as cars, trucks, armoured vehicles and similar, and see based vehicles, such as ships, submarines in surface position, amphibious crafts.

### BACKGROUND

Today's artillery enables combating of targets at distances of several tenths of kilometres with metre precision. Precision guided munitions are available that with high precision can hit a target if it is pointed out correctly. It is no longer the weapon that is the restricting part but it is the defining of coordinates that sets the limits. It is a requirement that the absolute position of the target must be determined with an accuracy of a few metres when the target is observed at a distance of several kilometres. This is difficult in many cases.

Generally most systems used today to determine the position of a target is based on the measuring of azimuth and distance from a known position. When locating targets at distances of above some kilometres, accuracy problems arise. Using a laser range finder with azimuth facility improves the accuracy but still the accuracy has to be improved for targets far away. This in particular holds in the case that there is no clear line of sight for the laser range finder. One drawback with the above described systems is that an error in the target locating increases with the distance to the target.

Another drawback is that you expose yourself when you measure the distance to the target with a laser range finder.

There are also indications of a system collecting information from different sensors in a database in order to image a terrain in question with accurate coordinates. An observer then compares his view of the terrain with the information in the database.

Another method considered is to locate the target by means of an unmanned areal vehicle, UAV. Starting from the position and azimuth of the UAV, the UAV measures angle and distance to the target. This is quite possible but the camera platform in the UAV including its gimbal arrangement and the position determining system of the UAV are very complicated and due to that expensive. Nevertheless the accuracy is not expected to increase compared to systems discussed above.

The object of this invention is to obtain a method and a system offering high accuracy in the position determining of a target to a low cost using non complicated instrumentation and available equipment.

### SUMMARY OF THE INVENTION

The object is obtained by a method by the following steps:
a) recording images of a target area by means of recording devices carried by a vehicle,
b) making a three dimensional image of the target area available from a stored three dimensional map covering the target area and its surroundings,
c) matching the recorded images of the target area with a corresponding three dimensional area of the three dimensional map comprising transferring a target indicator, such as a reticle, from the recorded images of the target area to the three dimensional map of the corresponding target area,
d) reading the coordinates of the target indicator position in the three dimensional map,
e) making the read coordinates of the target indicator position available for position requiring equipment.

The object is also obtained by a target locating system characterized in that that the vehicle comprises an image recording device and a transmitter, that the ground based system comprises a receiver receiving images from the vehicle pointing out a target, a storing unit comprising three dimensional maps of terrain, a matching unit comparing images received from the image recording device with images from the three dimensional maps, a coordinate reader reading the coordinates of the three dimensional map point coinciding with the target pointed out in the image received from the vehicle, a transmitter transmitting coordinate information to the position requiring equipment, and that the position requiring equipment comprises a receiver receiving the target coordinate information transmitted from the ground based system.

The method and system is essentially based upon the idea to match the recorded images taken from the vehicle with three dimensional images available from in advance generated three dimensional maps. Expressed in another way the target seen from the UAV is placed in an available three dimensional map. The placing or locating is carried out by comparing the target surrounding with corresponding parts in the three dimensional map. The indicator or reticle position in the UAV image is transferred to the three dimensional map in which the exact coordinates are read. This matching or aligning is preferably carried out automatically.

By means of the invention claimed a method and system are obtained offering inter alia the following advantages.
Accurate target locating
Simple instrumentation. Simple operating UAV:s can be used without modifications. The image processing can be carried out in ground based systems.
Possible to update the position of a moving target.

Due to the fact that the coordinates in the three dimensional map are very precise the locating of the target in terms of coordinates will be very exact and distinct. The mounting of the recording devices to the vehicle is non-critical and recording platforms of simple construction can be used. Furthermore the positioning of the vehicle with recording devices is not at all critical.

According to a preferred development of the method the making, matching, reading and making of items b) to e) are carried out in a ground based system. In this connection preferably the vehicle carrying recording devices is separated from the ground based system. By carrying out these operations in a ground based system separated from the vehicle a cheaper solution is obtained. It is also possible that the ground based system is used to supply a plurality of vehicles.

According to yet another preferred development of the method the read coordinates are made available for position requiring equipment operating as a target combating equipment such as an artillery piece. In this application field the method clearly improves the hit probability for targets at great distances and in particular for targets at least partly hidden from the location of the artillery piece.

Advantageously the recording devices are carried by an unmanned aerial vehicle, UAV. Such vehicles are already available and provided with recording devices such as different kinds of cameras the vehicles offer a good overview of a supervised terrain.

According to still another preferred development of the method the recording of images of a target area by means of recording devices is continuously updated and necessary steps of items b) to e) repeated so that the target position is kept up to date. By continuously updating the position of a target almost instantaneous target position coordinates are available all the time.

Many different recording processes are possible. In particular it is proposed according to the target locating method to use video recording, photo recording or infra red recording for the recording of images. It is also proposed to combine at least two different types of recording. The proposed recording processes do not exclude other types of sensor arrangements.

By analogy with the recording process of the method it is also proposed a target locating system comprising a recording device operating as a video camera, photo camera or infra red camera.

### BRIEF DESCRIPTION OF THE DRAWINGS

The invention will now be described in more detail with reference to the accompanying drawings in which:

FIG. 1 schematically shows a vehicle with a recording device covering area with a target position to be located.

FIG. 2 schematically shows a target locating system.

FIG. 3 schematically shows a flow chart illustrating the target locating method according to the invention.

### DETAILED DESCRIPTION

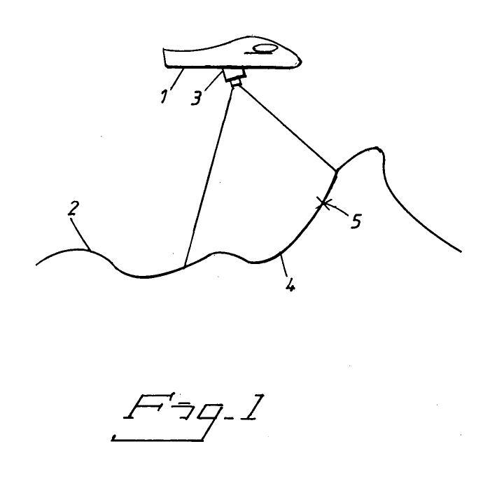

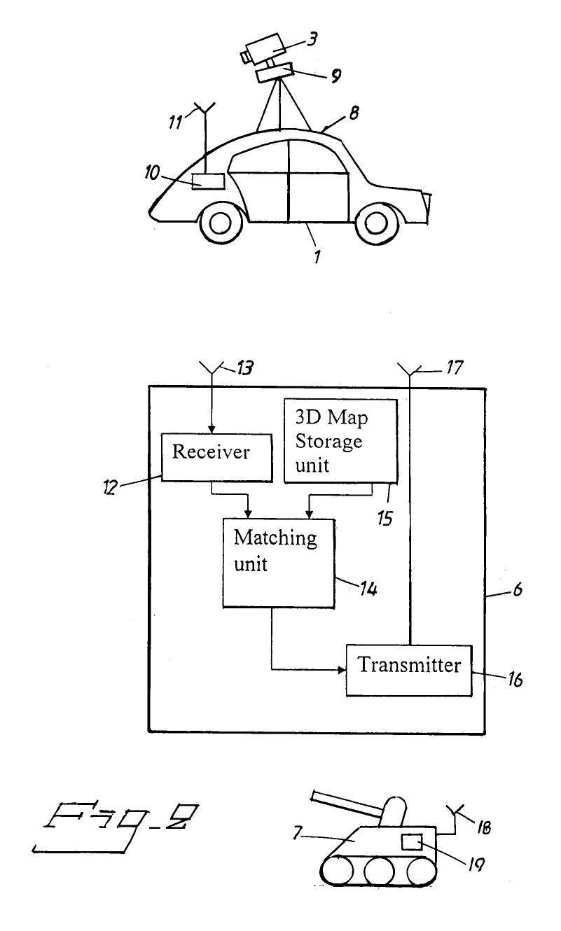

In FIG. 1 an areal vehicle 1, such as an unmanned areal vehicle, UAV, is shown flying above a landscape 2. The vehicle is provided with a camera 3 directed to a territory 4. Examples of suitable cameras are video cameras, photo cameras or infra red cameras. Other kinds of sensor arrangements are also possible. Within the territory there is a target 5 to be located with high accuracy. The vehicle is in contact with an evaluation system 6 as shown in FIG. 2. The evaluation system can be provided within the vehicle but preferably it is separately provided as a ground based evaluation system.

According to target locating system shown in FIG. 2, the system comprises a vehicle 1, a ground based evaluation system 6 and a position requiring equipment 7.

In this case the vehicle 1 is shown as a car provided with a camera 3 on top of the car roof 8. The camera 3 is mounted on an only symbolically indicated camera platform 9 so that the camera can be directed in desired directions. The car is provided with a transmitter 10 and an antenna 11 to so that the camera recordings can be transferred to the ground based evaluation system 6.

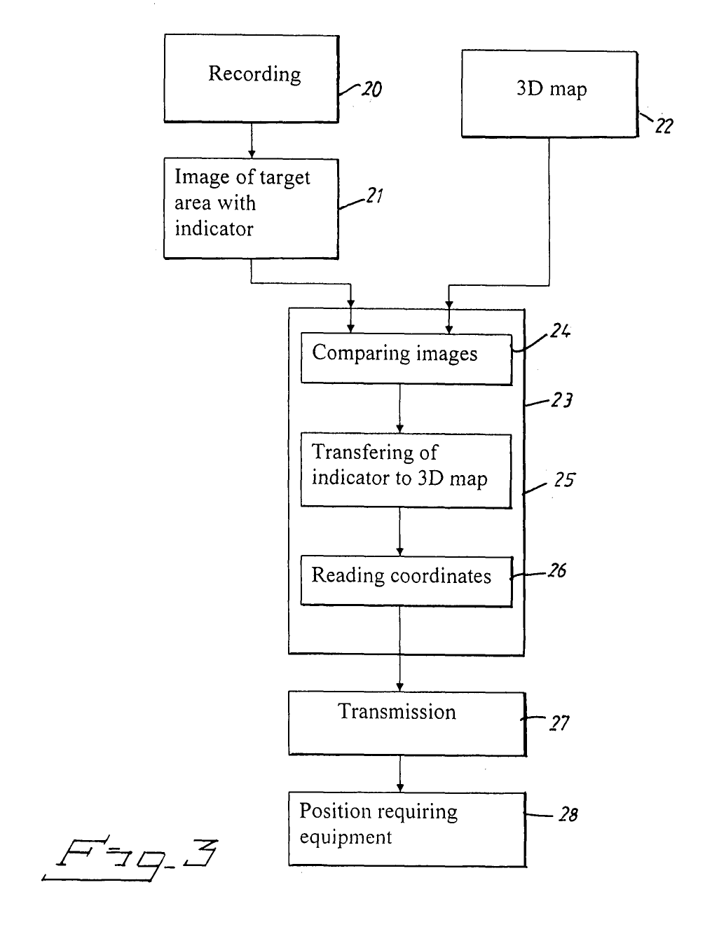

The evaluation system 6 comprises a receiver 12 with an antenna 13 receiving camera recordings from the vehicle transmitter 10. The received recordings are matched in a matching unit 14 with a 3D map stored in a storage unit 15. The matching unit outputs coordinate positions of a target as described in more detail with reference to FIG. 3. These coordinates are transmitted to the position requiring equipment 7 by means of a transmitter 16 and an antenna 17.

The position requiring equipment 7, such as an artillery piece, receives the coordinate information via an antenna 18 and a receiver 19. Based upon the received coordinate information it is ensured that munitions fired from the piece with very high accuracy hit the target.

The target locating method and target locating system will now be described in more detail below with reference to the flow chart of FIG. 3.

Block 20 indicates that recordings by cameras from a vehicle are taken. These recordings contain an image of a target area and an indicator such as a reticle and are available in block 21. In a block 22 a three dimensional map is stored. For example three dimensional maps obtained by the Rapid 3D Mapping method developed by Saab Bofors Support AB can be used, where photos taken over an area from different aspect angles are compiled to a three dimensional picture.

The images recorded by a vehicle and images from the three dimensional map are applied to a matching block 23 comprising an image comparing block 24 comparing the surroundings of the target with an corresponding area of the three dimensional map. According to block 25 the position of an indicator or reticle in the vehicle image is transferred to the three dimensional map. When the indicator or reticle is identified in the three dimensional map the coordinates of the indicator can be read. This is illustrated by block 26.

These read coordinates are transmitted to a position requiring equipment illustrated by block 27 and further to block 28 using the coordinate information for suitable purposes.

The invention is not limited to the examples described above but may be modified within the scope of the attached claims. For example there are other applications than pointing out targets in connection to artillery pieces. One application could be to indicate targets or areas in forestry. Another application could be to obtain more exact localisation of power lines and power line pylons. A third example of an application field could be within road and railway networks.

1. A target locating method, the method comprising:
recording images of a target area utilizing recording devices carried by a vehicle,
making a three dimensional image of the target area available from a stored three dimensional map covering the target area and surroundings of the target area,
matching the recorded images of the target area with a corresponding three dimensional area of the three dimensional map comprising transferring a target indicator from the recorded images of the target area to the three dimensional map of the corresponding target area,
reading the coordinates of the target indicator position in the three dimensional map, and
making the read coordinates of the target indicator position available for position requiring equipment.

2. The method according to claim 1, wherein the making, matching, reading and making are carried out in a ground based system.

3. The method according to claim 2, wherein the vehicle carrying recording devices is separated from the ground based system.

4. The method according to claim 1, wherein the read coordinates are made available for position requiring equipment operating as a target combating equipment.

5. The method according to claim 1, wherein the recording devices are carried by an unmanned aerial vehicle.

6. The method according to claim 1, wherein the recording of images of a target area utilizing recording devices is continuously updated and at least portions of the making, matching, reading and making repeated so that the target position is kept up to date.

7. The method according to claim 1, wherein video recording is used for the recording of images.

8. The method according to claim 1, wherein photo recording is used for the recording of images.

9. The method according to claim 1, wherein infra red recording is used for the recording of images.

10. The method according to claim 1, wherein the recording of images involves at least two different types of recording.

11. A target locating system, comprising:
a vehicle comprising an image recording device and a transmitter,
a ground based system comprising a receiver configured to receive images from the vehicle pointing out a target, a storing unit comprising three dimensional maps of terrain, a matching unit comparing images received from the image recording device with images from the three dimensional maps, a coordinate reader configured to read the coordinates of the three dimensional map point coinciding with the target pointed out in the image received from the vehicle, a transmitter configured to transmit coordinate information, and
a position requiring equipment comprising a receiver configured to receive the target coordinate information transmitted from the ground based system.

12. The target location system according to claim 11, wherein the recording device is a video camera.

13. The target location system according to claim 11, wherein the recording device is a photo camera.

14. The target location system according to claim 11, wherein the recording device is an infra red camera.

15. The method according to claim 1, wherein the a target indicator comprises a reticle.

16. The method according to claim 1, wherein the target combating equipment comprises an artillery piece.
